(19) United States
(12) Patent Application Publication
(10) Pub. No.: US 2014/0116043 A1
(43) Pub. Date: May 1, 2014

(54) DRIVE TRAIN, IN PARTICULAR VEHICLE DRIVE TRAIN

(71) Applicant: Voith Patent GmbH, Heidenheim (DE)

(72) Inventors: Ralf Hirzel, Welzheim (DE); Thomas Figler, Crailsheim (DE)

(73) Assignee: Voith Patent GmbH, Heidenheim (DE)

(21) Appl. No.: 14/149,361

(22) Filed: Jan. 7, 2014

Related U.S. Application Data
(63) Continuation of application No. PCT/EP2012/002663, filed on Jun. 23, 2012.

(30) Foreign Application Priority Data
Jul. 7, 2011 (DE) 10 2011 107 436.1

(51) Int. Cl. F02B 37/00

(52) U.S. Cl. CPC F02B 37/004
USPC 60/612; 60/605.1

(57) ABSTRACT

A drive train having an internal combustion engine which includes an output shaft feeding drive power into the drive train. A first turbo charger includes a first exhaust-gas turbine arranged in an exhaust-gas flow and mounted rotatably in a turbine housing that drives a first fresh-air compressor via a first turbine shaft. A turbo-compound system includes a power turbine arranged in the exhaust-gas flow and can be drive connected via a power turbine shaft to the output shaft, with the power turbine shaft mounted rotatably in a power turbine housing and extending parallel to the turbine shaft. The turbine housing and power turbine housing can be supported in or on or integrated into a transmission housing. The first turbocharger is arranged radially outside the turbo-compound system. The first turbocharger and turbo-compound system are arranged on a common side or on different and adjoining or opposite sides of the transmission housing.

### CROSS REFERENCE TO RELATED APPLICATIONS

This is a continuation of PCT application No. PCT/EP2012/002663, entitled “DRIVE TRAIN, IN PARTICULAR VEHICLE DRIVE TRAIN”, filed Jun. 23, 2012, which is incorporated herein by reference.

### BACKGROUND OF THE INVENTION

1. Field of the Invention

The present invention concerns a drive train, in particular for a motor vehicle with a charged internal combustion engine.

2. Description of the Related Art

Vehicle drive trains with a turbo charged and mechanically charged internal combustion engine are well-known and are also designated as turbocharger—turbo compound systems. With the turbo charge, a fresh-air compressor, which compresses the fresh air fed to the internal combustion engine, is driven by means of an exhaust-gas turbine arranged in the exhaust-gas flow of the internal combustion engine. Generally, the drive connection between the exhaust-gas turbine and the compressor is purely mechanical.

With the turbo compound system, the driving power of the aforementioned exhaust-gas turbine or an additional exhaust-gas turbine, then called a power turbine, is charged in the exhaust gas flow of the internal combustion engine to provide purely mechanical drive power to the internal combustion engine, inasmuch as the power turbine drives the crankshaft of the internal combustion engine at least indirectly. There is usually a hydrodynamic coupling, in the drive connection between the power turbine and the crankshaft, for reducing torsional vibrations.

Generic turbo compound systems have been disclosed in documents:
DE 39 08 286 C1
DE 10 2009 033 519 AI
DE 10 2009 038 736 B3
DE 962 764 B
JP 6 248 966 A.

In particular, with the previous generic turbocharger—turbo compound systems, the turbocharger is traditionally connected to the housing of the internal combustion engine and separately to the turbo compound system. Since the turbocharger as well as the turbo compound system should be connected to the exhaust-gas flow as well as fresh-air flow and can be arranged according to the construction space requirements of the turbochargers, normally not directly to the turbo compound system, complex feeding and evacuation of the exhaust-gas flow and fresh-air flow with respect to both turbo machines are necessary. This requires, however, flow losses and has negative consequences on the overall efficiency of the exhaust-gas energy recovery. In addition to the non optimum use of the construction space, a separate lubricant supply is necessary for the turbo machines further to the different positions of installation. The maintenance involved for both separate turbo machines is also increased. These disadvantages also crop up if, for instance, a drive train is arranged with, instead of the turbo compound system, at least one additional fresh-air compressor and/or exhaust-gas turbine.

### SUMMARY OF THE INVENTION

The object of the present invention is to provide a drive train with which the aforementioned disadvantages are reduced. In particular, the available construction space should be better utilized for such a turbocharger—turbo compound system and the feeding and evacuation of the exhaust-gas flow or fresh-air flow, and to do so the lubricant supply as well to the relatively mobile parts of such a turbocharger—turbo compound system can be improved. In particular, the maintenance involved for such a turbocharger—turbo compound system can be reduced.

The invention in one form is directed to a vehicle drive train having an internal combustion engine generating an exhaust-gas flow, which comprises an output shaft for feeding drive power into the drive train, presents at least one first turbocharger, comprising a first exhaust-gas turbine arranged in the exhaust-gas flow, which drives at least one first fresh-air compressor via a first turbine shaft, which is arranged in a fresh-air flow conveyed to the internal combustion engine, wherein the turbine shaft is mounted rotatably in a turbine housing, and at least one turbo compound system, comprising at least one power turbine, which is arranged in the exhaust-gas flow and is drive-connected or can be drive-connected via a power-turbine shaft to the output shaft of the internal combustion engine, wherein a stationary, non rotating transmission comprising a transmission housing is associated with the turbo compound system and the power turbine shaft is mounted rotatably in the transmission housing. To do so, the turbine housing is supported in or on the transmission housing or is integrated therein. The first turbocharger is arranged partially or completely axially inside the turbo compound system or the turbo compound system is arranged partially or completely inside the first turbocharger, the turbine shaft and the power turbine shaft extend parallel to one another and the first turbocharger is arranged radially outside the turbo compound system.

Since the turbine housing, which presents the bearing(s) to support the torque of the turbine shaft, is associated with the transmission housing of the turbo compound system and in particular is surrounded partially or completely by said system, it can be dispensed with an additional installation of the turbocharger on the internal combustion engine, as it is known in the art.

In other words, the bearing(s) of the first turbocharger—the ones used for supporting the first turbine shaft—and the bearing(s) of the turbo compound system—the one(s) for supporting the power turbine shaft and/or a compressor shaft of the turbo compound system—support the torque on said housing, namely the transmission housing are mounted and in particular surrounded by the latter partially or completely.

This configuration enables not only reduced assembly costs but also can reduce the construction space due to the geographical proximity of the position of installation of the turbocharger with respect to the turbo compound system. Moreover, to lubricate the relatively mobile parts of the turbocharger, in particular the turbine shaft, the same lubricating oil supply as used for lubricating the power turbine shaft of the turbo compound system can be employed. Further, the flow losses are decreased by a particularly short flow guide of the exhaust-gas flow and fresh-air flow to the turbo machines of the turbocharger—turbo compound system, whereby the degree of efficiency of the latter is increased. A plurality of single- or multistage turbochargers and/or power turbines can be provided, which can be designed as previously described and arranged in the fresh-air flow or exhaust-gas flow.

The first turbocharger and the turbo compound system can be arranged on a common side or on different and in particular adjoining or opposite sides of the transmission housing.

A second embodiment of the drive train of the invention, in particular of a vehicle drive train having an internal combustion engine generating an exhaust gas flow, comprises an output shaft for feeding drive power into the drive train, at least one first turbocharger is provided, comprising a first exhaust-gas turbine arranged in the exhaust-gas flow, which via a first turbine shaft drives at least one first fresh-air compressor, which is arranged in a fresh-air flow conveyed to the internal combustion engine, wherein the turbine shaft is mounted rotatably in a turbine housing. Further, at least one second fresh-air compressor is provided, which is arranged in the fresh-air compressor, in particular upstream of the first fresh-air compressor and is drive-connected or can be drive-connected via a compressor shaft to the output shaft of the internal combustion engine, wherein a stationary, non rotating transmission comprising a transmission housing is associated with the second fresh-air compressor and the compressor shaft is mounted rotatably in the transmission housing. The turbine housing is supported in or on the transmission housing or is integrated therein.

The turbine housing can also as be arranged completely or partially inside the transmission housing or be surrounded by the latter completely or partially. So the bearing(s) of the first turbocharger—i.e. the one(s) to support the first turbine shaft—and the bearing(s) to support the compressor shaft of the second fresh-air compressor to support the torque can be mounted on the same housing, i.e. the transmission housing and can be surrounded in particular by said housing partially or completely.

Another embodiment of the drive train of the invention, in particular of a vehicle drive train having an internal combustion engine generating an exhaust gas flow, comprises an output shaft for feeding drive power into the drive train. At least one first turbocharger is provided, comprising an exhaust-gas turbine arranged in the exhaust-gas flow which drives at least one first fresh-air compressor via a first turbine shaft, which is arranged in a fresh-air flow conveyed to the internal combustion engine, wherein the first turbine shaft is mounted rotatably in a turbine housing and is drive-connected or can be drive-connected to at least one second exhaust-gas turbine, which is arranged in the exhaust-gas flow, in particular downstream of the first exhaust-gas turbine, and via a second turbine shaft to the first turbine shaft of the first turbocharger, wherein a stationary, non rotating transmission comprising a transmission housing is associated with the second exhaust-gas turbine and the second turbine shaft is mounted rotatably in the transmission housing. Alternately, or additionally, at least one second fresh-air compressor is provided which is arranged in the fresh-air compressor, in particular upstream of the first fresh-air compressor and is drive-connected or can be drive-connected via a compressor shaft with the first turbine shaft of the first turbocharger, with the compressor shaft mounted rotatably in the transmission housing. The turbine housing is supported in or on the transmission housing or is integrated therein.

The turbine housing can be arranged completely or partially inside the transmission housing or be surrounded completely or partially by the latter. So the bearing(s) of the first turbocharger—i.e. the one(s) to support the first turbine shaft—and the bearing(s) to support the compressor shaft of the second fresh-air compressor and/or the second turbine shaft of the second exhaust-gas turbine to support the torque can be mounted on the same housing, i.e. the transmission housing and can be surrounded in particular by said housing partially or completely.

The aforementioned bearings, in particular exclusively arranged inside the transmission housing, can be supported directly or indirectly on the turbine housing for torque supporting purposes.

The first exhaust-gas turbine of the first turbocharger can be arranged in the exhaust-gas flow upstream of said at least one power turbine. To do so, a second fresh-air compressor can be associated with the turbo compound system. The turbo compound system drives said compressor via the power turbine shaft whereas the second fresh-air compressor can be arranged upstream of the first fresh-air compressor in the fresh-air flow. In so doing, the degree of efficiency of the fresh-air compression can be improved via a two-stage compression, whereas the second fresh-air compressor can be driven mechanically via the power turbine or also by the output shaft of the internal combustion engine. This two-stage charge can also be achieved by a reverse configuration of the continuous flow machines, i.e. with a positioning of the power turbine upstream of the exhaust-gas turbine and/or a positioning of the first fresh-air compressor upstream of the second fresh-air compressor.

In the drive connection between the power turbine and the output shaft and/or in the presence of a second fresh-air compressor, which can be driven via the power turbine shaft, between the power turbine and the second fresh-air compressor or with the execution of the drive train according to an embodiment of the invention, a hydrodynamic coupling can be arranged between the second fresh-air compressor and the output shaft, comprising a bladed primary wheel and a bladed secondary wheel, which together form a toroidal working chamber, which can be filled or is filled with working medium, to transmit the driving power hydrodynamically from the primary wheel to the secondary wheel. To do so, the primary wheel can be mechanically drive-connected to the power turbine and the secondary wheel can be mechanically drive-connected to the output shaft or, in the presence of the second fresh-air compressor, to the second fresh-air compressor. The hydrodynamic coupling is then arranged inside the transmission housing. If the working medium of the hydrodynamic coupling is both the lubricant for lubricating the bearings of the turbocharger—turbo compound system, there is no need to add a working medium supply of the hydrodynamic coupling. Consequently, additional structural elements such as cables for supplying the working medium or for sealing the working medium with respect to the transmission housing or to the environment are dispensed with. Such a hydrodynamic coupling therefore can be arranged in mechanical drive connection between the power turbine and the fresh-air compressor and additionally or alternately between the output shaft (crankshaft) and the power turbine.

It can be useful if in the drive connection between the power turbine shaft and the output shaft and/or between the power turbine shaft and the second fresh-air compressor or with the execution of the drive train according to an embodiment of the invention, a toothed gear transmission such as a spur gear transmission is arranged between the second fresh-air compressor and the output shaft and can be placed before or after the hydrodynamic coupling in the direction of the power transmission from the power turbine to the output shaft or from the output shaft to the second fresh-air compressor, and the toothed gear transmission is arranged inside the transmission housing. In such a case, the lubricant supply can not only serve for lubricating said elements, but also moreover for conveying lubricants such as oil to the toothed gear transmission, which enables to reduce the number of structural elements of such a turbocharger—turbo compound system. The hydrodynamic coupling could also be arranged in a drive connection between the first turbine shaft of the first turbocharger and the second turbine shaft of the second exhaust-gas turbine and/or between the first turbine shaft and the compressor shaft of the second fresh-air compressor.

The power turbine and the first exhaust-gas turbine can present an exhaust-gas inlet for supplying exhaust gas and an exhaust-gas outlet for evacuating exhaust gas from the respective turbine (power turbine or exhaust-gas turbine). The first fresh-air compressor and the second fresh-air compressor include an air inlet for supplying fresh air to the respective fresh-air compressor as well as an air outlet for evacuating fresh air from said compressor. To do so, the exhaust gas outlet of the exhaust-gas turbine is connected via an exhaust-gas manifold in a flow-guiding fashion to the exhaust-gas inlet of the power turbine and the air outlet of the second fresh-air compressor is connected via a fresh-air manifold in a flow-guiding fashion to the fresh-air inlet of the first fresh-air compressor, whereas the fresh-air manifold and the exhaust-gas manifold are 90 degree elbows. The exclusive use of an exhaust-gas manifold and of a fresh-air manifold designed in such a way enables to reduce the flow losses contrary to air and exhaust-gas guiding system, which is considerably more costly with respect to the state of the art, which increases the overall efficiency of the turbocharger—turbo compound system.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic arrangement of the different components of a drive train of the invention;

FIGS. 2a and 2b are schematic arrangements of the different components of a drive train of the invention;

FIG. 3 is an additional schematic arrangement of the different components of a drive train of the invention; and

FIGS. 4a to 4d show additional schematic arrangements of the different components of the drive train according to different embodiments of the invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

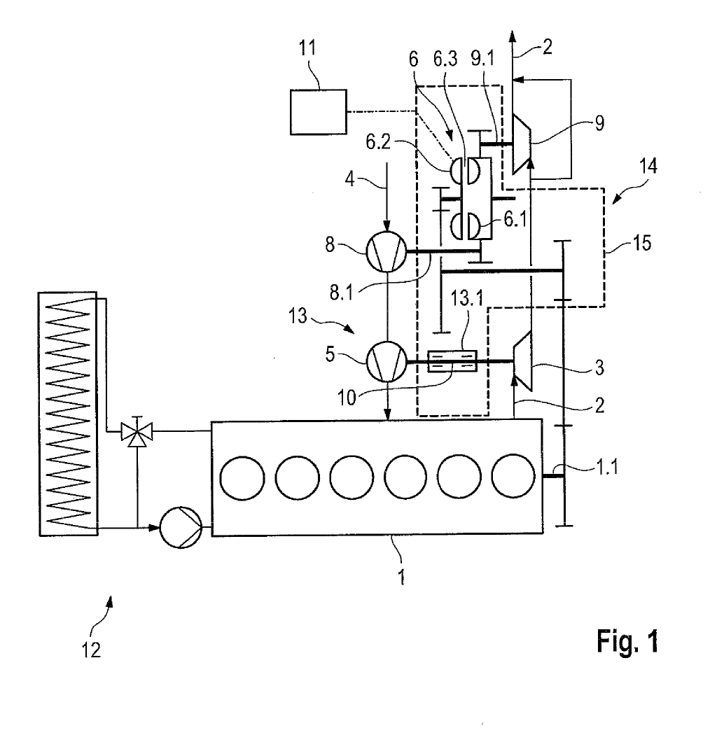

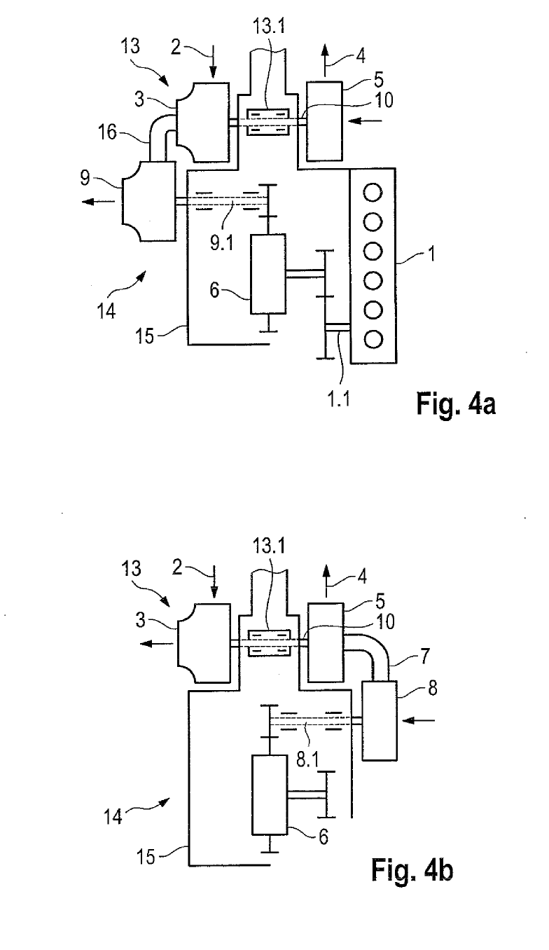

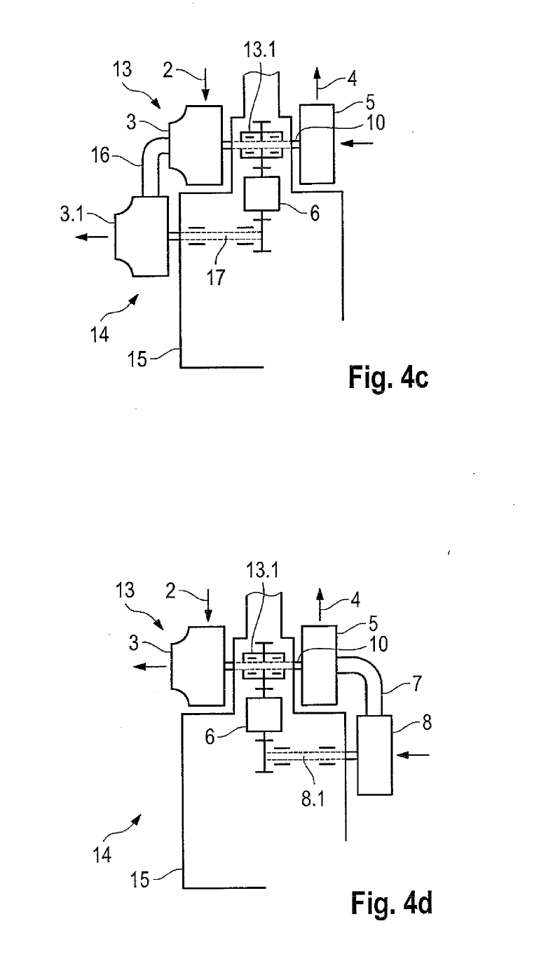

FIG. 4a shows a drive train of the invention according to one embodiment of the invention, comprising an internal combustion engine 1, such as a diesel engine, having an output shaft 1.1 which can be, for instance, a crankshaft of the internal combustion engine 1. The internal combustion engine 1 is cooled by means of a cooling circuit 12, as shown in FIG. 1. The internal combustion engine 1 generates an exhaust-gas flow 2. Two turbines, namely a first exhaust-gas turbine 3 of a turbocharger 13 and a second turbine, here designated as power turbine 9, are arranged in a row relative to one another and are subjected to exhaust gas from the exhaust-gas flow 2 so that they convert exhaust-gas energy into drive power.

To do so, the power turbine 9 is arranged in the flow direction of the exhaust gas behind the first exhaust-gas turbine 3 in the exhaust-gas flow 2. The first fresh-air compressor 5 is connected via a common shaft, here a first turbine shaft 10, to the first exhaust-gas turbine 3 or alternately, the respective impellers of the first fresh-air compressor 5 and of the first exhaust-gas turbine 3, here designed as turbo machines, are supported by the first turbine shaft 10. The first fresh-air compressor 5 includes a high-pressure stage, whereas conversely the first exhaust-gas turbine 3 includes a low-pressure stage. The exhaust-gas turbine 3 can have a multi-stage design or a plurality of additional exhaust-gas turbines placed upstream or downstream from the exhaust-gas turbine 3 in the exhaust-gas flow 2. The same goes for the fresh-air compressor 5.

The driving energy taken from the exhaust-gas flow 2 via the power turbine 9 is transmitted mechanically to the output shaft, as described in more detail below. Matching components are designated with matching reference numerals.

FIG. 1 shows in the flow direction of the fresh air 4 a second fresh-air compressor 8 arranged before the first fresh-air compressor 5, the second compressor having a low pressure stage and being driven with the power turbine 9. The drive connection illustrated is again purely mechanical, i.e. not a turbo charged drive connection. The drive power is transmitted from a power turbine shaft 9.1 of the power turbine 9 via a toothed gear, particularly a spur wheel stage to a primary wheel 6.1 of a hydrodynamic coupling 6, then via a second toothed gear stage, again designed as a spur wheel stage, further to a compressor shaft 8.1 of the second fresh-air compressor 8, which then supports the corresponding impeller wheel of the second fresh-air compressor 8 rotatably. The power turbine 9 is hence part of a turbo compound system 14 to transmit the drive power from the power turbine 9 to the output shaft 1.1 of the internal combustion engine 1. Also, several power turbines 9 can be provided connected behind one another. The same goes for the additional turbochargers.

The compressor shaft 8.1 as well as the power turbine shaft 9.1 are shown as separate components, but could be designed as a single part. As illustrated in the figures, all the shafts represented extend parallel to one another. This is, however, not strictly necessary, and individual or even all shafts can extend at an angle, for instance with an angle ranging between 0 and 15° inclusive or even at right angles relative to one another. Other variations are also possible.

The power turbine 9 is drive-connected both via the hydrodynamic coupling 6 to the output shaft 1.1 of the internal combustion engine 1, and in such a way that the drive connection is guided through a working chamber 6.3 composed of the primary wheel 6.1 and a secondary wheel 6.2, in which a flow circuit of working medium can be formed. Thus, power is transmitted hydrodynamically from the primary wheel 6.1 to the secondary wheel 6.2, to dampen torsional vibrations which crop up in the drive train.

By changing the filling level of the working chamber 6.3 of the hydrodynamic coupling 6, the power transmission with the hydrodynamic coupling 6 can be controlled or regulated to be more accurate in a first operating mode when the power is transmitted from the output shaft 1.1 via the hydrodynamic coupling 6 to the first fresh-air compressor 8 as well as in a second operating mode when the power is transmitted from the power turbine 9 via the hydrodynamic coupling 6 to the output shaft 1.1. A control device 11 is provided for the specific adjustment of the filling level in the working chamber 6.3, which engages the hydrodynamic coupling 6 for controlling or regulating purposes accordingly, inasmuch as it opens and/or closes a valve (not shown) in the feed line and/or a valve (not shown) in the evacuation line of the working chamber into the working chamber, respectively, from the working chamber 6.3 and moves said valve in particular into a prescribed intermediate position (regulating position), which is indicated by the dotted line.

The first exhaust-gas turbine 3 as well as the power turbine 9 and the components in driving connection with said components such as the turbine shaft 10, the compressor shaft 8.1, the power turbine shaft 9.1 and the turbine housing 13.1 are hence surrounded by a transmission housing 15, as described below, and may consequently be regrouped to form a common transmission of the turbocharger—turbo compound system.

The section of the turbine shaft 10 arranged between the first fresh-air compressor 5 and the first exhaust-gas turbine 3 is mounted by means of the undesignated but still shown bearings in a turbine housing 13.1. The latter hence surrounds exclusively the turbine shaft 10 in said section along the whole circumferential direction in this instance. The turbine housing 13.1 is not mounted directly on the internal combustion engine 1 (or its housing), but is arranged inside the transmission housing 15 associated with the turbo compound system 14. The latter also includes the aforementioned shafts 8.1, 9.1, the hydrodynamic coupling 6, the spur wheel stages as well as the components in driving connection with said elements. The common arrangement of the turbine housing 13.1 with the transmission housing 15 allows providing simultaneously a lubricant supply (not shown) to both housing 13.1, 15. If the lubricant, which is conveyed via the lubricant supply to the transmission housing 15, is selected as a working medium supply of the hydrodynamic coupling 6, a separate working medium supply can be dispensed with. The transmission includes as an input shaft the power turbine shaft 9.1, which supports the impeller wheel of the power turbine or is connected to such a coupling element and is drive-connected with the primary wheel, as well as a first output shaft, here formed by the shaft which is illustrated but not designated, which is drive-connected to the secondary wheel, so as to be connected at least indirectly to the output shaft 1.1 and finally the compressor shaft 8.1 as a second output shaft, which is drive-connected with the input shaft and serves for driving the second fresh-air compressor 8.

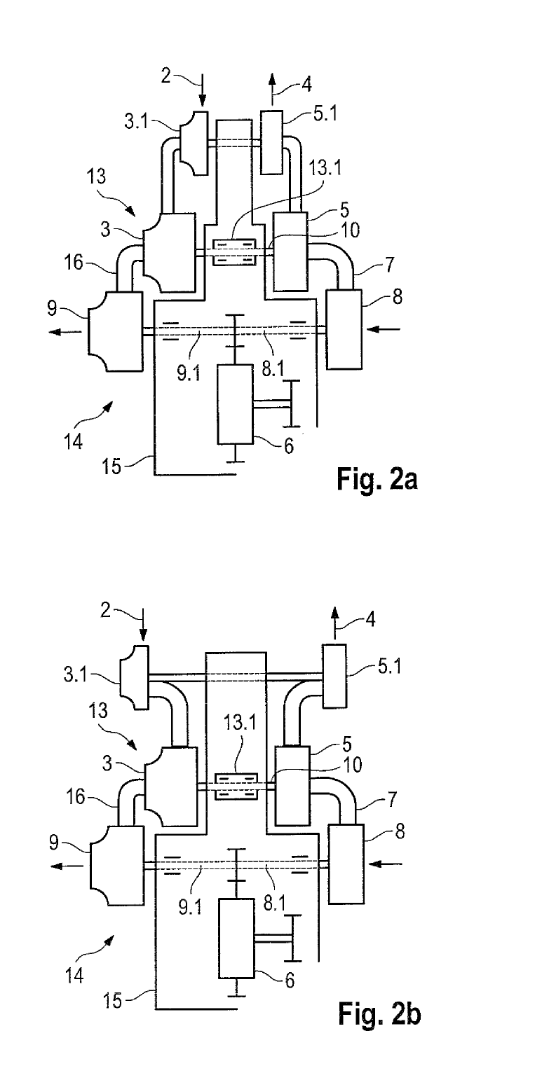

FIGS. 2a and 2b include two example arrangements of the different components of the drive train illustrated in FIG. 1 in an elevation view. Here again, matching components are designated with matching reference numerals. For the sake of clarity, all the structural elements are still not illustrated in FIG. 1.

FIG. 2a shows the turbo compound system 14 with its power turbine 9 as well as the second fresh-air compressor 8 and the turbocharger 13 with its first exhaust-gas turbine 3 as well as its first fresh-air compressor 5. The turbine housing 13.1 as well as the hydrodynamic coupling 6 are arranged inside the transmission housing 15, as represented in FIG. 1. Here, the turbine shaft 10 extends parallel to the power turbine shaft 9.1 and to the compressor shaft 8.1. This could also be different. In particular, the shafts could extend at an angle relative to one another, as was previously mentioned. The turbocharger 13 is hence arranged completely axially inside the turbo compound system 14. This means that the first exhaust-gas turbine 3 as well as the first fresh-air compressor 5 are limited in the axial direction from the power turbine 9 and from the second fresh-air compressor 8 and do not protrude beyond them. To do so, the part of the transmission housing 15 situated between both the second fresh-air compressor 8 and power turbine 9 includes an overhang which has a smaller size in the axial direction than the corresponding distance from the housing between the second fresh-air compressor 8 and the power turbine 9. This arrangement enables, when using fresh-air compressors 5, 5.1, 8 designed as radial compressors and/or as turbines 3, 3.1, 9 designed as radial turbines for simplifying the flow guide in the exhaust-gas flow 2 or more specifically in the fresh-air flow 4, using quarter-turn elbows (90 degree elbows) as manifolds. So, an exhaust-gas manifold 16 designed that way is provided between the first exhaust-gas turbine 3 and the power turbine 9. The latter connects an exhaust-gas outlet of the first exhaust-gas turbine 3 mounted in the axial direction of the turbocharger 13 with an exhaust-gas inlet mounted in the radial direction (with respect to the rotary axis of the power turbine 9), to guide the exhaust gas exiting the first exhaust-gas turbine 3 to the power turbine 9.

Such a manifold, designed as a fresh-air manifold 7, is analogically arranged in the fresh-air flow 4 between the first fresh-air compressor 5 and the second fresh-air compressor 8. The latter connects, for two-stage compression, an outlet of the second fresh-air compressor 8 oriented in the radial direction to an inlet of the first fresh-air compressor 5 oriented in the axial direction.

As shown in FIG. 2a, an additional turbocharger is provided, comprising a second exhaust-gas turbine 3.1 as well as a third fresh-air compressor 5.1. The second exhaust-gas turbine 3.1 is arranged in the exhaust-gas flow 2 in such a way that it is connected upstream of the first exhaust-gas turbine 3 of the first turbocharger 13. Accordingly, the third fresh-air compressor 5.1, which is arranged in the fresh-air compressor 4, is connected downstream of the first fresh-air compressor 5 in the flow direction of the fresh air. The additional turbocharger is for its own part arranged axially inside the first turbocharger 13, whereas an overhang of the part of the transmission housing 15 between the second exhaust-gas turbine 3.1 and the third fresh-air compressor 5.1 is accordingly smaller than it is in the case with the first turbocharger 13. The remaining components of the additional turbocharger are similar to those mentioned in FIGS. 1 and 2a.

FIG. 2b represents an additional embodiment of the drive train similar to that illustrated in FIG. 2a. The embodiment of FIG. 2b differentiates with regards to FIG. 2a in that the additional turbocharger delineates the first turbocharger 13 in the axial direction but is arranged axially inside the turbo compound system 14.

FIG. 4b shows another embodiment of the drive train of the invention. Compared to the drive train shown in FIGS. 1, 2a and 2b, a power turbine could be dispensed with. Consequently, an exhaust-gas turbocharger 13 is specified with an additional (separated mechanically from the exhaust-gas turbocharger 13) second fresh-air compressor 8 driven mechanically by the internal combustion engine. Since now the fresh-air compressor is driven mechanically via the non-illustrated output shaft, the hydrodynamic coupling 6 as well as the compressor shaft 8.1, the primary wheel (not shown) is, contrary to FIG. 4a, mechanically drive-connected with the output shaft whereas conversely the secondary wheel (also not shown) is drive-connected with the compressor shaft 8.1. The arrangement and the construction of the various components of the drive train illustrated can be similar to those shown in FIGS. 1, 2a, 2b and 4a.

FIGS. 4c and 4d show two alternative examples of arrangement of the drive unit according to another embodiment. Here again, matching components are designated with matching reference numerals. FIG. 4c represents a variation of the invention shown in FIG. 4a, whereas instead of the power turbine 9 shown in FIG. 4a, a conventional exhaust-gas turbine 3.1 is provided. The latter is drive-connected with the first turbine shaft 10 via a second turbine shaft 17, a toothed gear transmission and the hydrodynamic coupling 6. Consequently, the second exhaust-gas turbine serves for driving the first (common) fresh-air compressor 5.

FIG. 4d shows an additional example of arrangement of another embodiment of the drive train of the invention. FIG. 4d corresponds to a further development of the embodiment shown in FIG. 4b. The second fresh-air compressor 8 is not driven via the output shaft (not shown) of the internal combustion engine, but by the first turbine shaft 10. To do so, the hydrodynamic coupling 6 is arranged analogically to the representation in FIG. 4c between the first turbine shaft 10 and the compressor shaft 8.1. The hydrodynamic coupling 6 can be designed as already described in the figures, in particular as described in FIG. 4b.

Consequently, all the turbo machines can be mounted in the transmission housing 15 according to any of the embodiments, enabling optimum usage of the construction space, simplified lubrication of the mobile parts as well as optimisation of the flow guidance of the exhaust flow and fresh-air flow.

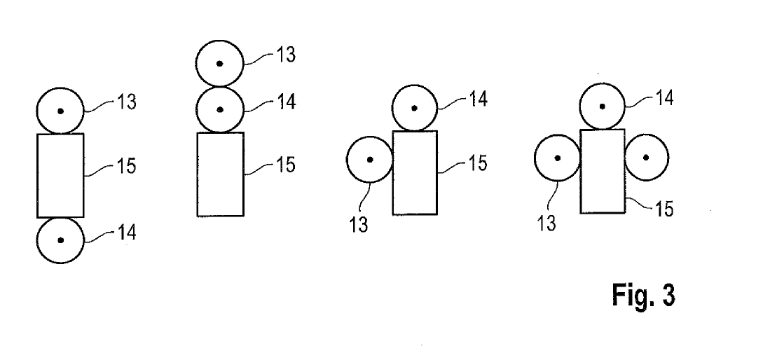

FIG. 3 represents, in a diagrammatical illustration, different examples of arrangement of the components of the drive train of the invention in a side view in the direction of the rotational axis, by way of example the turbine shaft 10 of FIGS. 2a and 2b. The components represented in the other figures can also be arranged according to FIG. 3.

The leftmost illustration shows that the turbocharger 13 and the turbo compound system 14 are arranged on sides of the transmission housing 15 opposite to one another. The turbocharger as well as the turbo compound system 14 could be arranged on the same side of the transmission housing 15 and in particular coplanar with respect to their rotational axes, as can be seen in the second illustration from the left of FIG. 3. As shown in the second illustration from the right of FIG. 3, the turbocharger 13 can be offset with respect to the turbo compound system in the circumferential direction so that the turbocharger 13 and the turbo compound system 14 are arranged on sides of the transmission housing 15 opposite to one another.

An additional possibility is that another turbocharger or a plurality of said turbochargers or even at least one additional turbo compound system, as shown by way of example for a further turbo machine in the rightmost illustration of FIG. 3, can be arranged on a further opposite side of the transmission housing 15.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle drive train, comprising:
an internal combustion engine including an output shaft for feeding drive power into the drive train, said internal combustion engine generating an exhaust-gas flow and having a fresh-air flow conveyed to said internal combustion engine;
at least one first turbocharger including a first exhaust-gas turbine arranged in the exhaust-gas flow and a turbine housing, said turbine housing having a first turbine shaft mounted rotatably within said turbine housing;
at least one first fresh-air compressor being arranged in said fresh-air flow conveyed to said internal combustion engine, said at least one first fresh-air compressor driven by said at least one first turbocharger via said first turbine shaft;
at least one turbo compound system including at least one power turbine and a power turbine shaft, said at least one turbo compound system being arranged in the exhaust-gas flow and is one of drive-connected and capable of being drive-connected via said power turbine shaft to said output shaft of said internal combustion engine;
a stationary, non rotating transmission including a transmission housing is associated with said at least one turbo compound system, said power turbine shaft being mounted rotatably in said transmission housing, wherein said turbine housing is one of supported in said transmission housing, supported on said transmission housing and integrated with said transmission housing;
the improvement comprising:
one of said at least one first turbocharger is arranged one of partially and completely inside said at least one turbo compound system and said at least one turbo compound system is arranged one of partially and completely inside said at least one first turbocharger, and
said first turbine shaft and said power turbine shaft extend parallel to one another and said at least one first turbocharger is arranged radially outside said at least one turbo compound system.

2. A vehicle drive train, comprising:
an internal combustion engine comprising an output shaft for feeding drive power into said drive train, said internal combustion engine generating an exhaust-gas flow and having a fresh-air flow conveyed to said internal combustion engine;
at least one first turbocharger comprising a first exhaust-gas turbine arranged in the exhaust-gas flow and a turbine housing, said turbine housing having a first turbine shaft mounted rotatably within said turbine housing;
at least one first fresh-air compressor arranged in the fresh-air flow conveyed to said internal combustion engine, said at least one first fresh-air compressor being driven by said at least one first turbocharger via said first turbine shaft;
at least one second fresh-air compressor arranged in the fresh-air flow upstream of said first fresh-air compressor; and
a stationary, non rotating transmission comprising a transmission housing having a compressor shaft mounted rotatably within said transmission housing, said transmission housing associated with said at least one second fresh-air compressor and said at least one second fresh-air compressor one of is drive-connected and can be drive-connected with said output shaft of said internal combustion engine via said compressor shaft, said turbine housing is one of supported in said transmission housing, supported on said transmission housing and integrated with said transmission housing.

3. A vehicle drive train, comprising:
an internal combustion engine comprising an output shaft for feeding drive power into said drive train, said internal combustion engine generating an exhaust-gas flow and having a fresh-air flow conveyed to said internal combustion engine;
a stationary, non rotating transmission comprising a transmission housing having at least one of a second turbine shaft and a compressor shaft mounted rotatably within said transmission housing;
at least one first fresh-air compressor arranged in the fresh-air flow conveyed to said internal combustion engine; and
at least one first turbocharger comprising a first exhaust-gas turbine arranged in the exhaust-gas flow and a turbine housing having a first turbine shaft mounted rotatably within said turbine housing, said at least one first fresh-air compressor being driven by said first turbine shaft, said turbine housing is one of supported in said transmission housing, supported on said transmission housing and integrated with said transmission housing, said at least one first turbocharger including at least one of:
at least one second exhaust-gas turbine arranged in the exhaust-gas flow downstream of said first exhaust-gas turbine, said transmission housing associated with said at least one second exhaust-gas turbine and said second exhaust-gas turbine one of is drive-connected and can be drive-connected with said first turbine shaft of said first turbocharger via said second turbine shaft; and
at least one second fresh-air compressor arranged in the fresh-air flow upstream of said first fresh-air compressor and one of is drive-connected and can be drive-connected with said first turbine shaft of the first turbocharger via said compressor shaft.

4. The drive train according to claim 1, further comprising at least one second fresh-air compressor arranged in the fresh-air flow upstream of said at least one first fresh-air compressor, wherein said first exhaust-gas turbine of said at least one first turbocharger is arranged in the exhaust-gas flow upstream of said at least one power turbine and said turbo compound system drives said at least one second fresh-air compressor via said power turbine shaft.

5. The drive train according to claim 1, further comprising a hydrodynamic coupling comprising a bladed primary wheel and a bladed secondary wheel which together form a toroidal working chamber which one of can be filled and is filled with working medium, said hydrodynamic coupling being arranged in the driving connection between said power turbine and said output shaft, said hydrodynamic coupling configured to transmit the driving power hydrodynamically from said bladed primary wheel to said bladed secondary wheel, said bladed primary wheel being mechanically drive-connected to said power turbine and said secondary wheel being mechanically drive-connected to said output shaft.

6. The drive train according to claim 4, further comprising a hydrodynamic coupling comprising a bladed primary wheel and a bladed secondary wheel which together form a toroidal working chamber which one of can be filled and is filled with working medium, said hydrodynamic coupling being arranged in the driving connection at least one of between said power turbine and said at least one second fresh-air compressor and between said power turbine and said output shaft, said hydrodynamic coupling configured to transmit the driving power hydrodynamically from said bladed primary wheel to said bladed secondary wheel, said bladed primary wheel being mechanically drive-connected to said power turbine and said secondary wheel being mechanically drive-connected to at least one of said at least one second fresh-air compressor and said output shaft.

7. The drive train according to claim 2, further comprising a hydrodynamic coupling comprising a bladed primary wheel and a bladed secondary wheel which together form a toroidal working chamber which one of can be filled and is filled with working medium, said hydrodynamic coupling being arranged between said at least one second fresh-air compressor and said output shaft, said hydrodynamic coupling configured to transmit the driving power hydrodynamically from said bladed primary wheel to said bladed secondary wheel, said bladed primary wheel being mechanically drive-connected to said output shaft and said secondary wheel being mechanically drive-connected to said compressor shaft.

8. The drive train according to claim 1, wherein said at least one first turbocharger and said at least one turbo compound system are arranged one of on a common side and on different sides of said transmission housing.

9. The drive train according to claim 1, wherein said at least one first turbocharger and said at least one turbo compound system are arranged on one of adjacent sides and opposite sides of said transmission housing.

10. The drive train according to claim 5, further comprising a toothed gear transmission arranged as a spur gear transmission in the drive connection between said power turbine shaft and said output shaft, said toothed gear transmission being arranged inside said transmission housing and placed one of before and after said hydrodynamic coupling in the direction of the power transmission seen from said power turbine to said output shaft.

11. The drive train according to claim 6, further comprising a toothed gear transmission arranged as a spur gear transmission in the drive connection at least one of between said power turbine shaft and said at least one second fresh-air compressor and between said power turbine shaft and said output shaft, said toothed gear transmission being arranged inside said transmission housing and placed one of before and after said hydrodynamic coupling in the direction of the power transmission seen from said power turbine to said output shaft.

12. The drive train according to claim 7, further comprising a toothed gear transmission arranged as a spur gear transmission in the drive connection between said at least one second fresh-air compressor and said output shaft, said toothed gear transmission being arranged inside said transmission housing and placed one of before and after said hydrodynamic coupling in the direction of the power transmission seen from said output shaft to said at least one second fresh-air compressor.

13. The drive train according to claim 1, wherein at least one of at least one of said exhaust-gas turbine and said power turbine is one of a radial turbine and an axial turbine and said at least one first fresh-air compressor is one of a radial compressor and an axial compressor.

14. The drive train according to claim 2, wherein at least one of at least one of said exhaust-gas turbine and said power turbine is one of a radial turbine and an axial turbine and at least one of said at least one first fresh-air compressor and said at least one second fresh-air compressor is one of a radial compressor and an axial compressor.

15. The drive train according to claim 4, wherein at least one of at least one of said exhaust-gas turbine and said power turbine is one of a radial turbine and an axial turbine and at least one of said at least one first fresh-air compressor and said at least one second fresh-air compressor is one of a radial compressor and an axial compressor.

16. The drive train according to claim 4, further comprising a fresh-air manifold and an exhaust-gas manifold that are both 90° elbows, wherein said power turbine and said exhaust-gas turbine each comprise an exhaust-gas inlet for feeding exhaust gas to said respective turbine and an exhaust-gas outlet for evacuating exhaust gas from said respective turbine, said at least one first fresh-air compressor and said at least one second fresh-air compressor each comprise an air inlet for feeding fresh air to said respective at least one fresh-air compressor and an air outlet for evacuating fresh air from said respective at least one fresh-air compressor, said exhaust gas outlet of said exhaust-gas turbine being connected via said exhaust-gas manifold in a flow-guiding fashion to said exhaust-gas inlet of said power turbine and said air outlet of said at least one second fresh-air compressor being connected via said fresh-air manifold in a flow-guiding fashion to said fresh-air inlet of said at least one first fresh-air compressor.
